(19) United States
(12) Patent Application Publication
(10) Pub. No.: US 2013/0298152 A1
(43) Pub. Date: Nov. 7, 2013

(54) Supporting multiple users from a single location sharing a media processing system via a personal media guide

(71) Applicant: BROADCOM CORPORATION, IRVINE, CA (US)

(72) Inventors: Marcus Kellerman, San Diego, CA (US); Jeyhan Karaoguz, Irvine, CA (US); James D. Bennett, Hroznetin (CZ)

(21) Appl. No.: 13/932,347

(22) Filed: Jul. 1, 2013

Related U.S. Application Data
(63) Continuation of application No. 10/674,672, filed on Sep. 30, 2003.
(60) Provisional application No. 60/470,263, filed on May 14, 2003.
(60) Provisional application No. 60/443,894, filed on Jan. 30, 2003.
(60) Provisional application No. 60/444,099, filed on Jan. 30, 2003.
(60) Provisional application No. 60/432,472, filed on Dec. 11, 2002.

(51) Int. Cl. H04N 21/485

(52) U.S. Cl. CPC H04N 21/485
USPC 725/25

(57) ABSTRACT

Systems and methods of supporting multiple users from a single location sharing a media processing system via a personal media guide are provided. In one embodiment, a system may comprise, for example, a communication device, media content, and a software platform. The communication device may be coupled to a communication network. The media content may be disposed in the communication network or the communication device, and the media content may comprise broadcast media and personal media. The software platform may reside on the communication device, and the software platform may further receive authentication information and facilitate a display of a user-defined selection from the media content by the communication device in a user-defined layout.

### CROSS-REFERENCE TO RELATED APPLICATIONS/INCORPORATION BY REFERENCE

The present U.S. Utility Patent Application claims priority pursuant to 35 U.S.C. §120, as a continuation of U.S. Utility patent application Ser. No. 10/674,672, filed on Sep. 30, 2003, which is incorporated herein by reference in its entirety for all purposes.

The Ser. No. 10/674,672 application claims priority under 35 U.S.C. §119(e) to U.S. Provisional Patent Applications 60/470,263, filed on May 14, 2003, 60/444,099, filed on Jan. 30, 2003, 60/432,472, filed on Dec. 11, 2002, and 60/443,894, filed on Jan. 30, 2003, all of which are incorporated herein by reference in their entirety for all purposes.

In addition, the Ser. No. 10/674,672 application incorporated by reference U.S. Provisional Patent Application No. 60/457,179, filed on Mar. 25, 2003, U.S. Utility patent application Ser. No. 10/657,390, filed on Sep. 8, 2003, and U.S. Utility patent application Ser. No. 10/660,267, filed on Sep. 11, 2003, all of which are also incorporated herein by reference in its entirety for all purposes in the present application.

### BACKGROUND OF THE INVENTION

Today, multiple users of e-mail on a PC (personal computer) at a single location may have their own personal e-mail accounts. For example, a family comprising a father, a mother, a son, and a daughter may each share a PC at their home and each have their own separate e-mail account. A particular e-mail account may be accessed by entering a code or a password. As a result, a level of privacy is accomplished between the multiple users in the family and the responsibility of managing e-mail is spread over the multiple users. For example, the father does not have to worry about wading through multiple e-mails from the daughter's boyfriend before finding an e-mail intended for him.

Also, for television viewing, family members view the same channel line-up on a displayed TV guide. Today, there is no customization, for each family member, with respect to using a TV channel guide and a TV remote control device.

Similarly, family members today may share a single cell phone plan and account. Each family member may have his own cell phone with a unique telephone number, again providing a certain level of privacy, convenience, and management of calls. For example, the mother does not have to worry about getting phone calls from the son's girl friend on the mother's cell phone. However, the family members share minutes from the same account and receive a single bill at the end of the month, which is paid for by the father who is the billing customer and user as far as the cell phone provider is concerned.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Aspects of the present invention may be found in, for example, systems and methods of supporting multiple users from a single location sharing a media processing system via a personal media guide. A system in accordance with an embodiment of the present invention may comprise, for example, a communication device, media content, and a software platform. The communication device may be coupled to a communication network. The media content may be disposed in the communication network or the communication device, and the media content may comprise broadcast media and personal media. The software platform may reside on the communication device, and the software platform may further receive authentication information and facilitate a display of a user-defined selection from the media content by the communication device in a user-defined layout.

In another embodiment, the system may comprise, for example, at least one processor disposed in a communication device, the communication device being communicatively coupled to a communication network. The at least one processor may receive information related to a user-defined selection from media content available on at least one of the communication network and the communication device. The processor may further receive authentication information entered into the communication network via the communication device and may analyze the authentication information to determine whether to display the user-defined selection on the communication device.

In another embodiment, the system may comprise, for example, a first display, a second display, a communication network, media content, and a software platform. The first display may be communicatively coupled to a first communication device. The second display may be communicatively coupled to a second communication device. The communication network may be communicatively coupled to the first communication device and the second communication device. The media content may be disposed in at least one of the communication network, the first communication device and the second communication device. The software platform may reside on the first communication device, so that the software platform receives information relating to a user-defined selection from media content and authorizes the delivery of the user-defined selection to at least one of the first display and the second display. The user-defined selection may be delivered in a user-defined layout.

In another embodiment, a method in accordance with the present invention may comprise, for example, one or more of the following: entering a first set of authentication information via a communication device communicatively coupled to a communication network, the first set of authentication information corresponding to a first user-defined selection from media content; displaying the first user-defined selection in a user-defined layout by the communication device upon validation of the first set of authentication information; resetting the communication device so that a second set of authentication information may be entered on the communication device; entering the second set of authentication information via the communication device, the second set of authentication information corresponding to a second user-defined selection from media content; and displaying the second user-defined selection in a user-defined layout by the communication device upon validation of the second set of authentication information.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating a first embodiment of a media exchange network supporting multiple personalized views of a TV channel guide user interface for users at a single location sharing a media processing system on the media exchange network, in accordance with various aspects of the present invention.

FIG. 1B is a diagram illustrating an embodiment of a TV channel guide user interface supporting multiple personalized views on the media exchange network of FIG. 1A, in accordance with various aspects of the present invention.

FIG. 1C is a diagram illustrating an embodiment of a personalized view of the TV channel guide user interface of FIG. 1B on the media exchange network of FIG. 1A, in accordance with various aspects of the present invention.

FIG. 2 is a flowchart illustrating an embodiment of a method to support multiple personalized views of a TV channel guide user interface for users at a single location sharing a media processing system on the media exchange network of FIG. 1A, in accordance with various aspects of the present invention.

FIG. 3 is a schematic block diagram of a first exemplary media exchange network in accordance with an embodiment of the present invention.

FIG. 4 is a schematic block diagram of performing personal media exchange over a second exemplary media exchange network in accordance with an embodiment of the present invention.

FIG. 5 is a schematic block diagram of performing third-party media exchange over a third exemplary media exchange network in accordance with an embodiment of the present invention.

FIG. 6 is an exemplary illustration of a TV guide channel user interface in accordance with an embodiment of the present invention.

FIG. 7 is an exemplary illustration of several instantiations of a TV guide channel user interface of FIG. 4 in accordance with an embodiment of the present invention.

FIG. 8 is an exemplary illustration of a TV guide channel user interface showing several options of a pushed media in accordance with an embodiment of the present invention.

FIG. 9A is a schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a PC and an MPS interfacing to a server on a media exchange network in accordance with an embodiment of the present invention.

FIG. 11 is a schematic block diagram of a PC interfacing to personal media capture devices and remote media storage on a media exchange network in accordance with an embodiment of the present invention.

### DETAILED DESCRIPTION OF THE INVENTION

Certain embodiments of the present invention relate to personalized media channels. In particular, certain embodiments of the present invention relate to setting up a personalized view in a TV channel guide user interface on a media processing system on a media exchange network. Personal broadcasting channels within a personalized view may be set up between parties on the media exchange network.

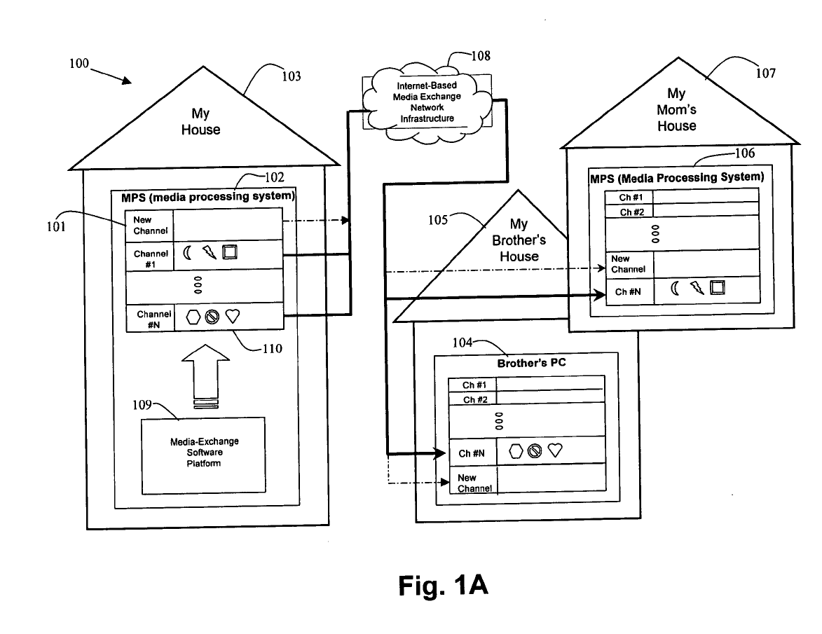

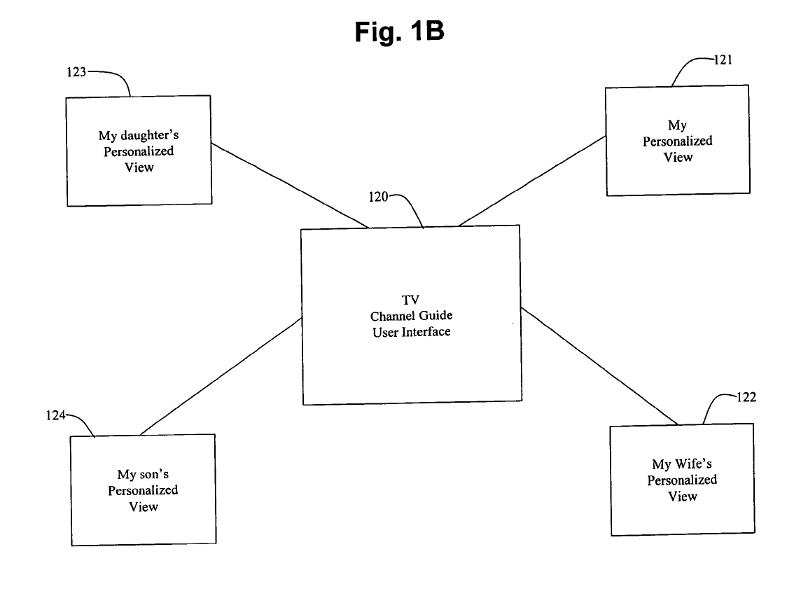

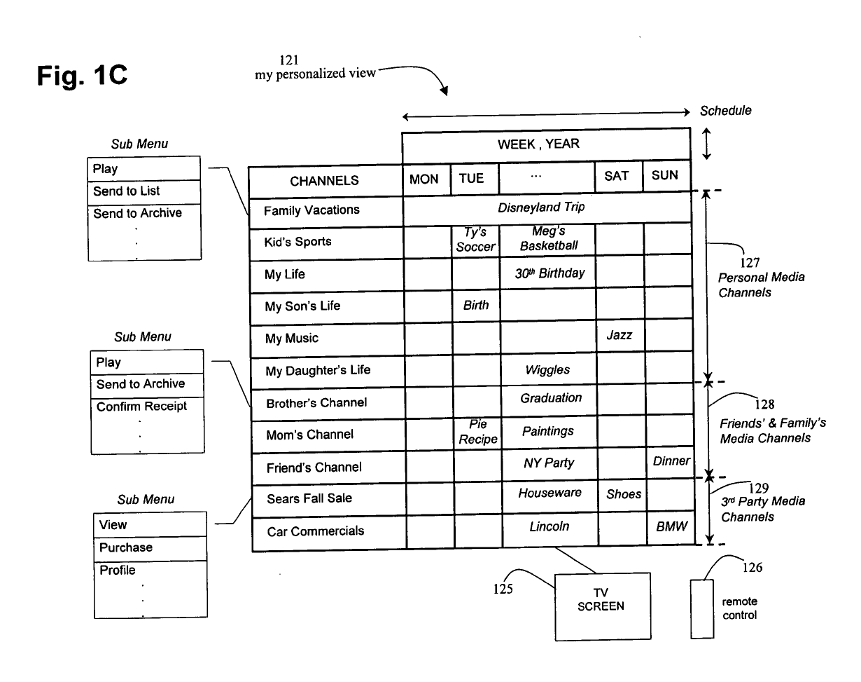

FIG. 1A is a diagram illustrating a first embodiment of a media exchange network 100 supporting multiple personalized views of a TV channel guide user interface 110 for users at a single location 103 sharing a media processing system 102 on the media exchange network 100, in accordance with various aspects of the present invention. Specifically, the media exchange network 100 is a communication network comprising an MPS (media processing system) 102 at “My House” 103, a brother's PC 104 at “My Brother's House” 105, and an MPS 106 at “My Mom's House” 107. The media exchange network 100 further comprises the Internet-based media exchange network infrastructure 108 which connects together the MPS 102, the PC 104, and the MPS 106.

In accordance with various embodiments of the present invention, an MPS may comprise a set-top box (STB), a PC, or a TV with a media management system (MMS). An MMS is also known herein as a media exchange software (MES) platform.

An MMS comprises a software platform operating on at least one processor to provide certain functionality including user interface functionality, distributed storage functionality, and networking functionality. For example, a MMS may provide control of media peripheral devices, status monitoring of media peripheral devices, and inter-home MPS routing selection, in accordance with an embodiment of the present invention.

The MPS's (102 and 106) are essentially enhanced set-top boxes. The MPS's (102 and 106) may each include a TV screen for viewing and interacting with various user interfaces, media, data, and services that are available on the media exchange network using, for example, a remote control. The PC 104 may include a PC monitor for viewing and interacting with various user interfaces, media, data, and services that are available on the media exchange network using, for example, a keyboard and mouse. The MPS's and PC include functional software to support interaction with the various elements of the media exchange network 100, in accordance with various embodiments of the present invention.

For example, the MPS 102 comprises a media exchange software (MES) platform 109. The MES platform 109 on the MPS 102 supports personalized views of media channels and set up of new media channels on the media exchange network 100. For example, the MES platform 109 provides a format, displayed on a monitor of the MPS 102, known as a TV channel guide user interface 110 to allow a user to set up a personalized view of the TV channel guide user interface 110 using a remote control. The MES platform 109 also provides the functionality for a user of the MPS 102 to set up a new media channel 101 in his personalized view.

In general, the MPS's 102 and 106 and the PC 104 each include a media exchange software (MES) platform and a networking component for connectivity. The MES platform provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated TV channel guide look-and-feel.

FIG. 1B is a diagram illustrating an embodiment of a TV channel guide user interface 120 supporting multiple personalized views on the media exchange network 100 of FIG. 1A, in accordance with various aspects of the present invention. The TV channel guide user interface 120 supports “My personalized view” 121, “My wife's personalized view” 122, “My daughter's personalized view” 123, and “My son's personalized view” 124 on the MPS 102 at “My House” 103. Each personalized view may include a unique set of media channels.

For example, FIG. 1C is a diagram illustrating an embodiment of “My personalized view” 121 of the TV channel guide user interface 120 of FIG. 1B on the media exchange network 100 of FIG. 1A, in accordance with various aspects of the present invention. The view 121 of the TV channel guide user interface 120 may be displayed on a TV screen 125 and controlled by a remote control device 126. Also, the view 121 of the TV channel guide user interface 120 may be displayed on a PC monitor and controlled by a keyboard or mouse.

Various types of channels may be set up by a user in his personal view, including personal media channels 127 that may be for private use, friend's and family's media channels 128 that may be shared by friends and family members, and third party media channels 129 that may be set up by third parties either upon request by a user of a media exchange network or based on a profile of a user. Also, broadcast media channels (i.e., channels provided by broadcast networks such as, for example, ABC, NBC, and CBS) may be set up in a personalized view.

The personal media channels 127 may include, for example, a “family vacations channel”, a “kid's sports channel”, a “my life channel”, a “my son's life channel”, a “my music channel”, and a “my daughter's life channel”. The friends and family media channels 128 may include, for example, a “brother's channel”, a “Mom's channel”, and a “friend's channel”. The third party media channels 129 may include, for example, a “Sears Fall sale channel” and a “car commercials channel”. The type of media that may eventually be stored in a media channel includes video, images, audio, text, and any other type of digital media that may be generated.

As indicated by FIG. 1A, the set up of a new media channel 101 may be accomplished via a PC or an MPS, in accordance with various embodiments of the present invention, and pushed, via the media exchange network 100, to other PC's and/or MPS's at other locations on the media exchange network. For example, referring to FIG. 1A, a user at “My House” 103 may set up a new channel 101 on the MPS 102 and push the new channel 101 to the PC 104 at “My Brother's House” 105 and the MPS 106 at “My Mom's House” 107. The PC 104 at “My Brother's House” 105 and the MPS 106 at “MY Mom's House” 107 may also support multiple personalized views.

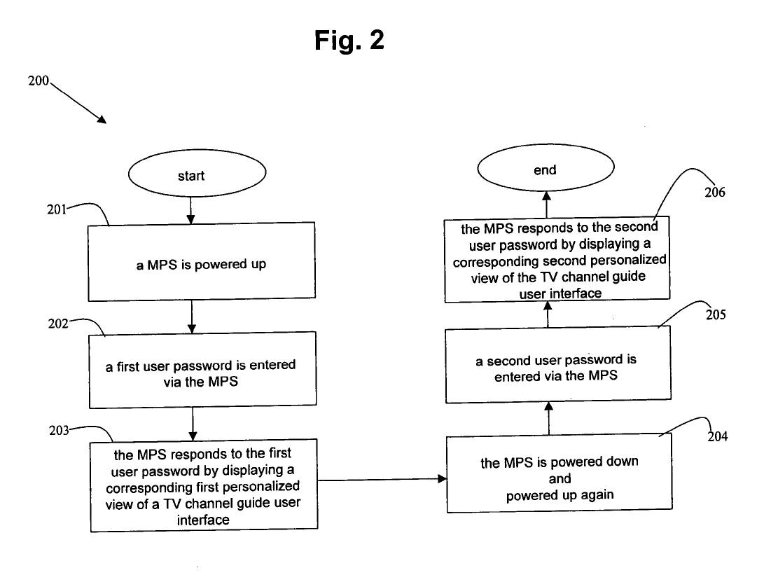

FIG. 2 is a flowchart illustrating an embodiment of a method 200 to support multiple personalized views of a TV channel guide user interface for users at a single location sharing a media processing system on the media exchange network 100 of FIG. 1A, in accordance with various aspects of the present invention. In step 201, an MPS is powered up. In step 202, a first user password is entered via the MPS. In step 203, the MPS responds to the first user password by displaying a corresponding first personalized view of a TV channel guide user interface. In step 204, the MPS is powered down and powered up again. In step 205, a second user password is entered via the MPS. In step 206, the MPS responds to the second user password by displaying a corresponding second personalized view of the TV channel guide user interface.

As an example, referring to FIG. 1A, a father at “My house” 103 powers up (i.e., turns on) the MPS 102 and enters his user password using a remote control. The MPS 102 responds to the user password by calling up and displaying the father's personalized view of the TV channel guide user interface 110. The father's personalized view may comprise the view 121 shown in FIG. 1B and FIG. 1C. The father may spend some time manipulating his personalized view 121 of the TV channel guide user interface 110 (e.g., creating a new channel, pushing a channel to another user, deleting a channel, selecting a channel to view, etc.). Eventually, the father finishes manipulating his personalized view 121 and powers down (i.e., turns off) the MPS 102.

Next, the daughter at “My house” 103 powers up (i.e., turns on) the MPS 102 and enters her user password using a remote control. The MPS 102 responds to the user password by calling up and displaying the daughter's personalized view of the TV channel guide user interface 110. The daughter's personalized view may comprise the view 123 shown in FIG. 1B. The daughter may spend some time manipulating her personalized view 123 of the TV channel guide user interface 110 (e.g., creating a new channel, pushing a channel to another user, deleting a channel, selecting a channel to view, etc.). Eventually, the daughter finishes manipulating her personalized view 123 and powers down (i.e., turns off) the MPS 102.

Similarly, the son and the wife may subsequently use the MPS 102 to call up, view, and manipulate their corresponding personalized views, 124 and 122 respectively, of the TV channel guide user interface 110.

In alternative embodiments of the present invention, a user may enter a unique, secure pin code or use voice keying (i.e., where the MPS or PC recognizes the user's voice) to call up his personalized view, instead of entering a password.

In accordance with various embodiments of the present invention, a personalized view may be set up in a TV channel guide user interface via an MPS, a PC, or from a web site. In accordance with an embodiment of the present invention, when a user connects an MP (media peripheral) device (e.g., a digital camera, a PDA, etc.) to an MPS or PC on a media exchange network, the MPS or PC may prompt the user to enter which personalized views the MP should be associated with. For example, a father may purchase a digital camera and desire that only he and his wife have the ability to use the digital camera with the MPS in their home, not their son or daughter.

Each user of an MPS or a PC supporting multiple personalized views of a TV channel guide user interface at one location on a media exchange network may construct and maintain a unique set of media channels (i.e., a unique channel line up) in their personalized view. The users at one location may create links and associations with other users of the media exchange network and exchange media, in accordance with various aspects of the present invention.

As a result, a certain level of privacy is established between users at the single location. That is, each of the different users only has access to his personalized view. Also, responsibility for managing the TV channel guide user interface is divided up in a logical manner between the various users. For example, a father does not have to worry about finding his media channels of interest among the media channels of the other family members. Each family member (i.e., user) manipulates and maintains his or her own view.

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a TV channel guide look-and-feel user interface. The media exchange network also allows a user to construct personal media channels that comprise his personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, set-top boxes or integrated MPS's (media processing systems) may be used with the media exchange network to perform all of the previously described media exchange functions using a remote control with a television screen.

Current set-top boxes may be software enhanced to create an MPS that provides full media exchange network interfacing and functionality via a TV screen with a TV guide look-and-feel. PC's may be software enhanced as well and provide the same TV guide look-and-feel. Therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, DSL, satellite, etc. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

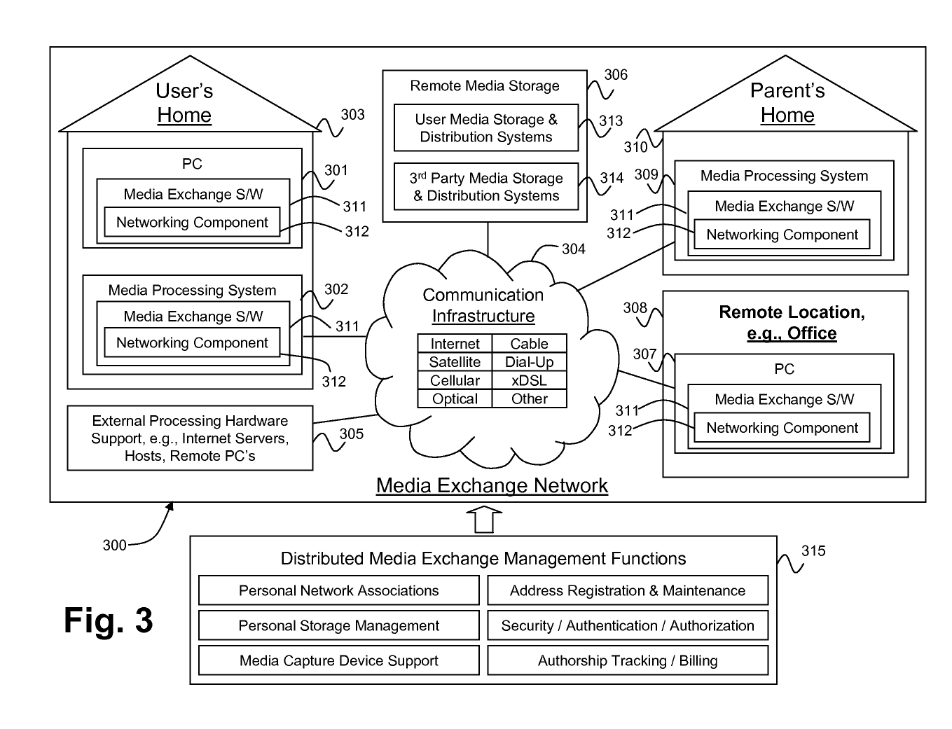

FIG. 3 illustrates a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated TV channel guide look-and-feel.

The external processing hardware support 305 comprises at least one server such as a centralized Internet server, a peer-to-peer server, or cable head end. The server may alternatively be distributed over various hosts or remote PC's. The MES platform 311 may also reside on the external processing hardware support server 305. The remote media storage 306 may comprise user media storage and distribution systems 313 and/or third party media storage and distribution systems 314.

The communication infrastructure 304 may comprise at least one of Internet infrastructure, satellite infrastructure, cable infrastructure, dial-up infrastructure, cellular infrastructure, xDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

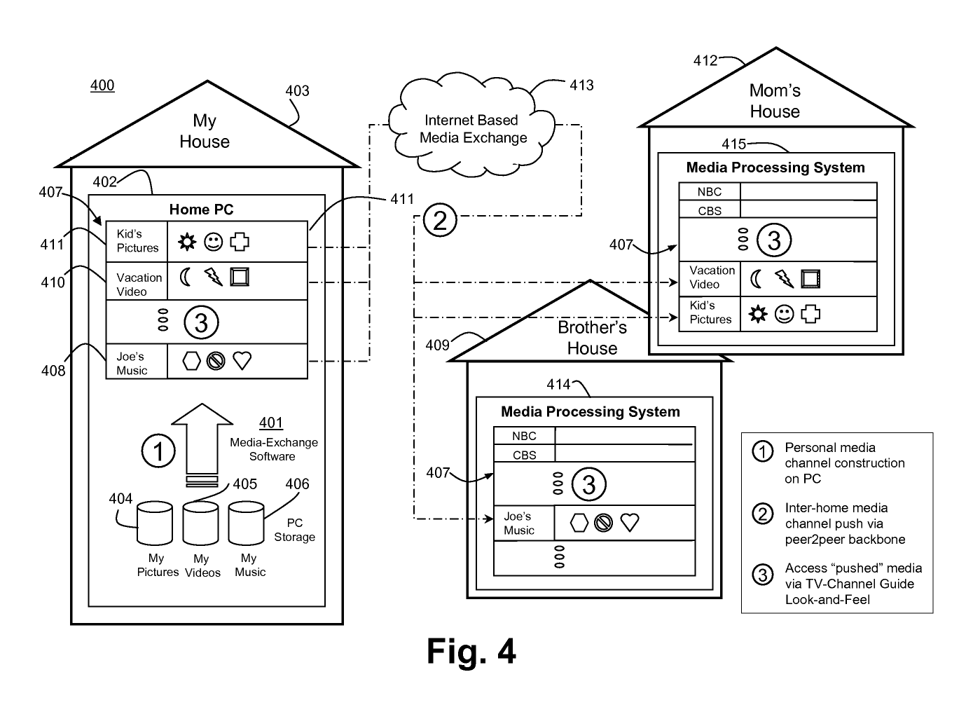

FIG. 4 illustrates an example of personal media exchange over a media exchange network 400 in accordance with an embodiment of the present invention. In step 1, the media exchange software (MES) platform 401 is used to construct personal media channels on a PC 402 by a user at “my house” 403. For example, with various media stored on the PC 402 such as digital pictures 404, videos 405, and music 406, the MES platform 401 allows the digital media to be organized by a user into several channels having a TV channel guide look-and-feel user interface 407 on the PC 402.

In step 2, the user at “my house” 403 pushes a media channel 408 (e.g., “Joe's Music”) to “brother's house” 409 and pushes two media channels 410 and 411 (e.g., “Vacation Video” and “Kid's Pictures”) to “Mom's house” 412 via a peer-to-peer server 413 over the Internet-based media exchange network 400. “Brother's house” 409 includes a first MPS 414 connected to the media exchange network 400. “Mom's house” 412 includes a second MPS 415 connected to the media exchange network 400. The MPS's 414 and 415 also provide a TV channel guide look-and-feel user interface 407.

In step 3, brother and/or Mom access the pushed media channels via their respective media processing systems (MPS's) 414 and 415 using their respective MPS TV screens and remote controls.

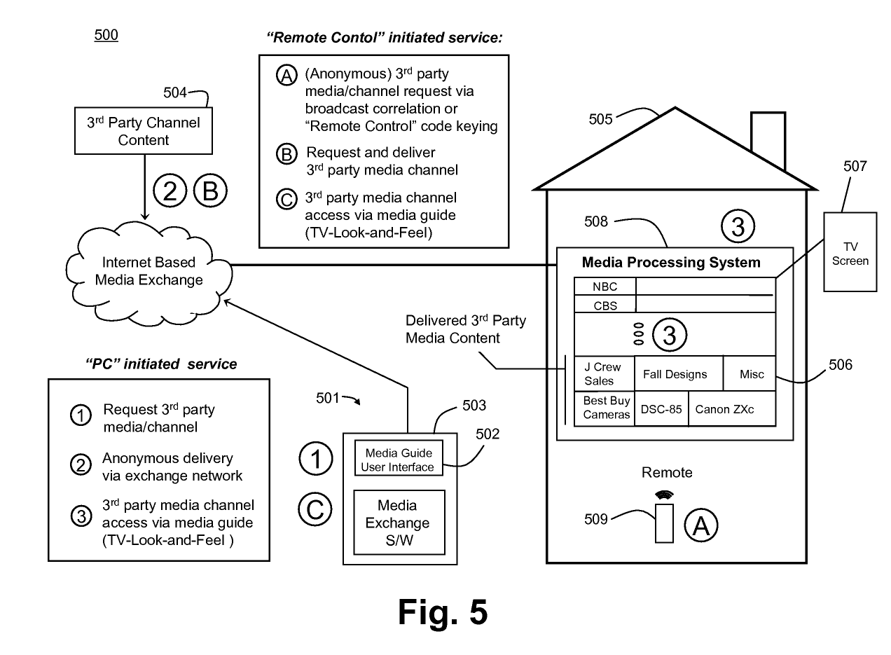

FIG. 5 illustrates an example of third-party media exchange over a media exchange network 500 in accordance with an embodiment of the present invention. In step 1, a PC-initiated third-party request is made by a first party 501 via an Internet-based media exchange network 500 using a TV channel guide look-and-feel user interface 502 on a PC 503. In step 2, an anonymous delivery of the requested third-party channel 504 is made to a second party 505 via the Internet-based media exchange network 500. In step 3, the second party 505 accesses the third-party channel 504 using a TV channel guide look-and-feel user interface 506 on a TV screen 507 that is integrated into an MPS 508.

Similarly, in step A, an MPS-initiated third-party request is made by a second party 505 via an Internet-based media exchange network 500 using a TV channel guide look-and-feel user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the Internet-based media exchange network 500. In step C, the first party 501 accesses the third-party channel 504 using a TV channel guide look-and-feel user interface 502 on a PC 503.

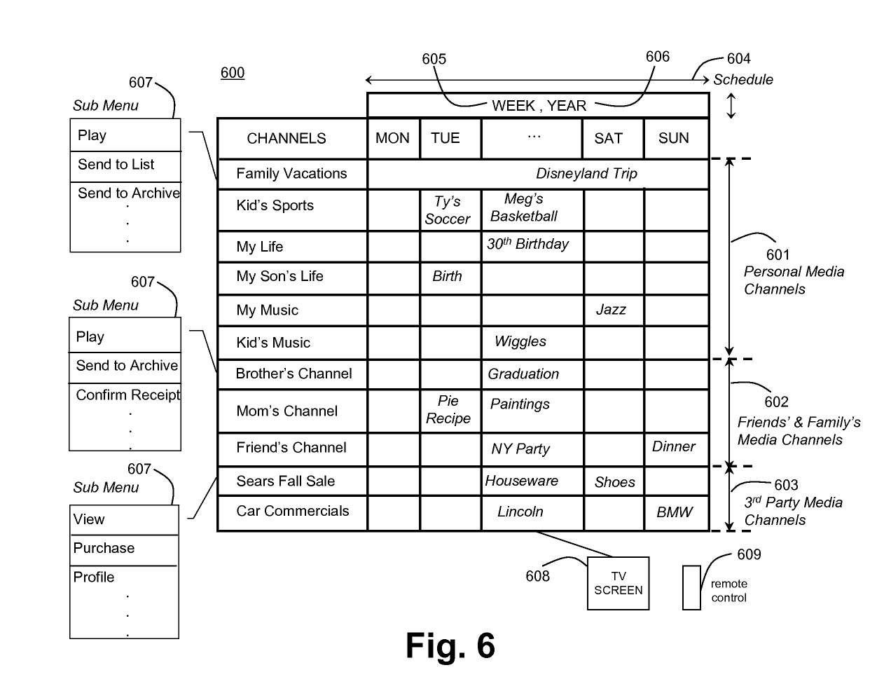

FIG. 6 illustrates a TV channel guide user interface 600 in accordance with an embodiment of the present invention. The TV channel guide user interface 600 may be displayed on a TV screen 608 and controlled by a remote control device 609. Also, the TV channel guide user interface 600 may be displayed on a PC monitor and controlled by a keyboard or mouse.

The TV channel guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

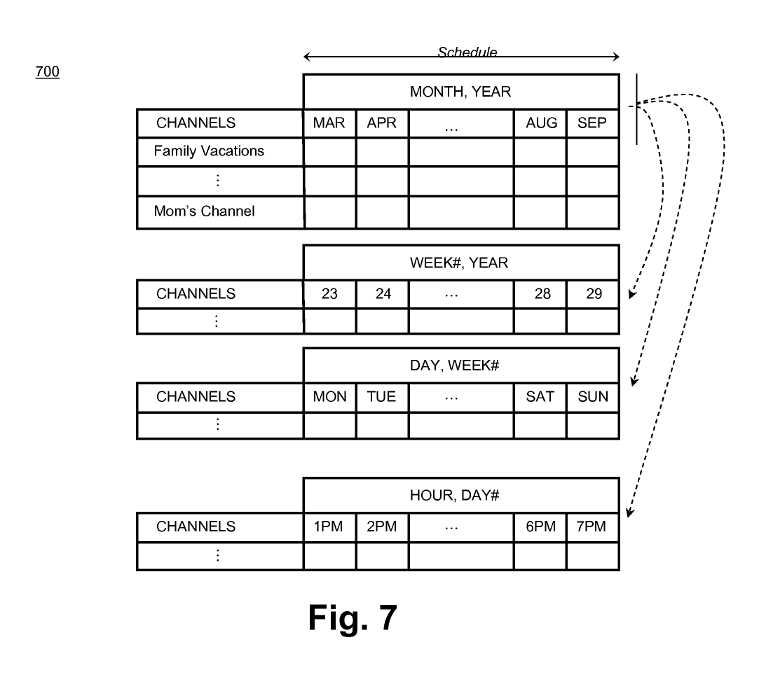

FIG. 7 illustrates possible multiple instantiations of a TV channel guide user interface 700 in accordance with an embodiment of the present invention. The TV channel guide user interface 700 may be viewed with a schedule having formats of, for example, “month, year”, “week#, year”, “day, week#”, or “hour, day”.

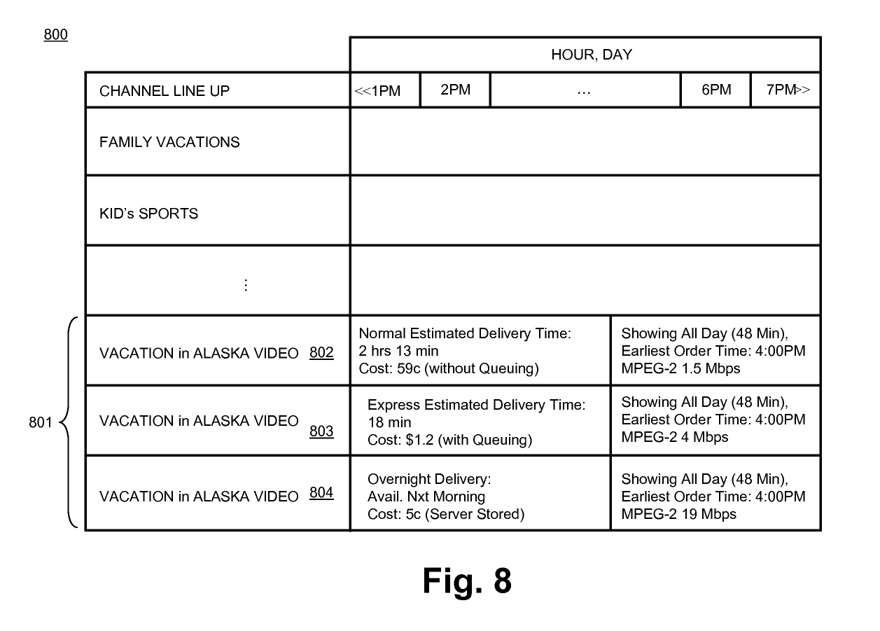

Referring to FIG. 8, a user of a media exchange network may push a media channel (e.g., “Vacation in Alaska Video”) to a friend who is on the same media exchange network. The TV channel guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

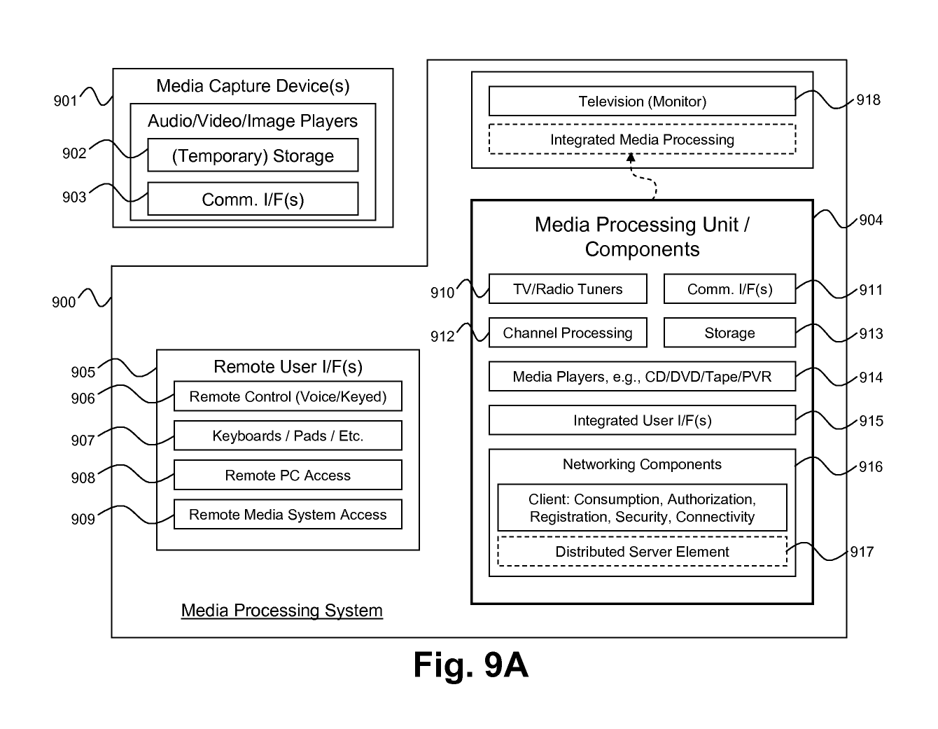

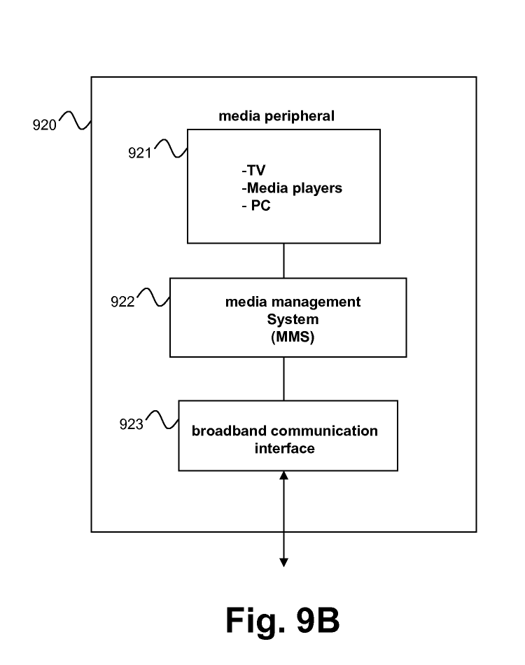

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and an MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

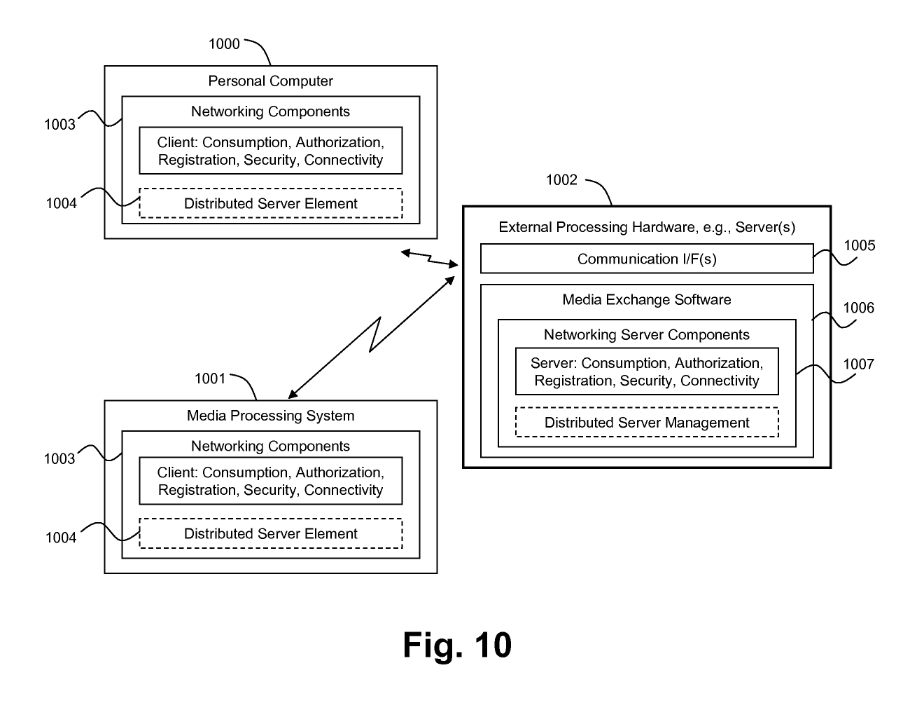

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

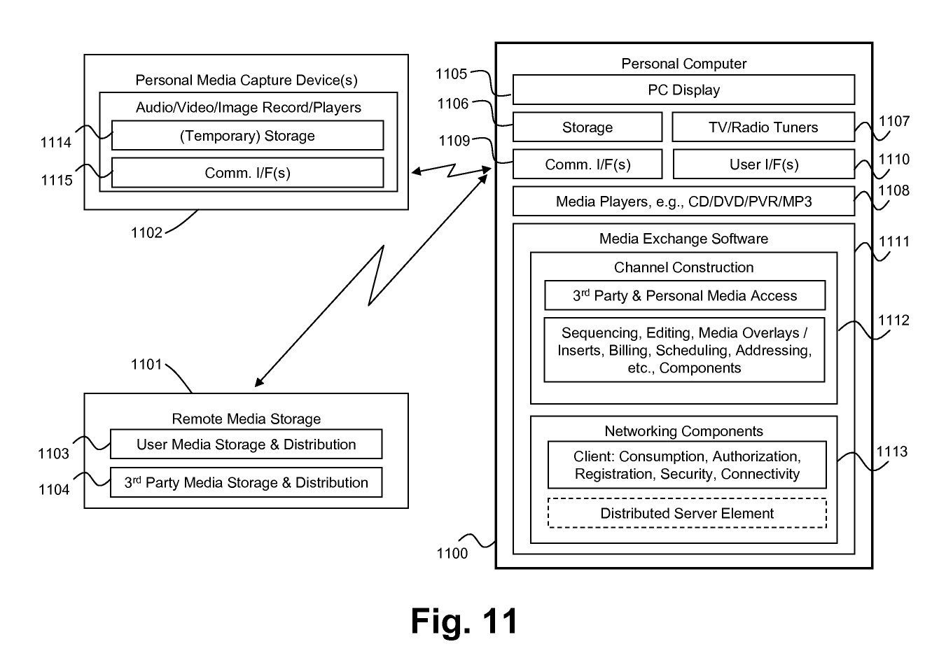

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 instead of a television screen. The PC 1100 may include storage 1106, TV/radio tuners 1107 for media consumption, media players 1108, and communication interfaces 1109 and user interfaces 1110 similar to those for the MPS of FIG. 9. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

In summary, some embodiments of the present invention may relate to a system and method that provide the ability to support multiple personalized views of a TV channel guide user interface for users at a single location sharing a media processing system on a media exchange network.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the invention not be limited to the particular embodiment disclosed, but that the invention will include all embodiments falling within the scope of the appended claims.

What is claimed is:

1. A system to support personalized visual presentations of media content on a display for a plurality of users at a single location, in which the personalized visual presentations are constructed by individual users and are based on different selection of media content by the individual users, the system comprising:
a storage to store the media content;
a user interface operable to provide visual presentations on the display and to receive user input in response to the visual presentations on the display; and
a processor, coupled to the storage and to the user interface, to present visual presentations of the stored media content for user interaction to permit a user to construct a personalized visual presentation by selecting personalized portions of the media content and to tailor the selected personalized portions of the media content into a program guide for viewing on the display as user's personalized visual presentation, wherein the processor to construct different personalized visual presentations of correspondingly selected personalized portions of the media content, respectively for the plurality of users accessing the system at the single location, and the processor to respond to a unique authentication information from an accessing user to display a corresponding personalized visual presentation to the accessing user of the plurality of users that constructed the personalized visual presentations.

2. The system of claim 1, wherein the processor, when constructing the different personalized visual presentations, also provides for broadcast channels to be included for selection in the personalized visual presentations.

3. The system of claim 1, wherein the processor, when constructing the different personalized visual presentations, also provides for third party content to be included for selection in the personalized visual presentations.

4. The system of claim 1, wherein the unique authentication information is a password entered by the accessing user in order to bring up the accessing user's personalized visual presentation on the display.

5. The system of claim 1, wherein the processor pushes one or more of the personalized visual presentations to another location to access portions of the media content corresponding to the pushed personalized visual presentation at the another location.

6. The system of claim 1, wherein when a media peripheral is coupled to the system, the processor prompts a user coupling the media peripheral to which personalized visual presentation to associate the media peripheral.

7. The system of claim 1, wherein when a media peripheral is coupled to the system, the processor prompts a user coupling the media peripheral to select which personalized visual presentation or presentations to associate the media peripheral and only associates the media peripheral with the selected personalized visual presentation or presentations.

8. A system to support personalized visual presentations of media content on a display for a plurality of users at a single location, in which the personalized visual presentations are constructed by individual users and are based on different selection of media content by the individual users, the system comprising:
a storage to store the media content;
software that is operable to provide visual presentations on the display and to receive user input in response to the visual presentations on the display to construct a plurality of personalized visual presentation for users at the single location; and
a processor, coupled to the storage and operating on the software, to present visual presentations of the stored media content for user interaction to permit a user to construct a personalized visual presentation by selecting personalized portions of the media content and to tailor the selected personalized portions of the media content into a tailored channel guide for viewing on the display as user's personalized visual presentation, wherein the processor to construct different personalized visual presentations of correspondingly selected personalized portions of the media content, respectively for the plurality of users accessing the system at the single location, and the processor to respond to a unique authentication information from an accessing user to display a corresponding personalized visual presentation to the accessing user of the plurality of users that constructed the personalized visual presentations.

9. The system of claim 8, wherein the processor, when constructing the different personalized visual presentations, also provides for broadcast channels to be included for selection in the personalized visual presentations.

10. The system of claim 8, wherein the processor, when constructing the different personalized visual presentations, also provides for third party content to be included for selection in the personalized visual presentations.

11. The system of claim 8, wherein the system is part of a set-top box.

12. The system of claim 8, wherein the unique authentication information is a password entered by the accessing user in order to bring up the accessing user's personalized visual presentation on the display.

13. The system of claim 8, wherein the display is a television set.

14. The system of claim 8, wherein the processor pushes one or more of the personalized visual presentations to another location to access portions of the media content corresponding to the pushed personalized visual presentation at the another location.

15. The system of claim 8, wherein when a media peripheral is coupled to the system, the processor prompts a user coupling the media peripheral to which personalized visual presentation to associate the media peripheral.

16. The system of claim 8, wherein when a media peripheral is coupled to the system, the processor prompts a user coupling the media peripheral to select which personalized visual presentation or presentations to associate the media peripheral and only associates the media peripheral with the selected personalized visual presentation or presentations.

17. A method of supporting personalized visual presentations of media content on a display for a plurality of users at a single location, in which the personalized visual presentations are constructed by individual users and are based on different selection of media content by the individual users, the method comprising:
utilizing a processing system and a display to provide visual presentations of stored media content on the display and to receive user input in response to the visual presentations on the display;
constructing a personalized visual presentation for the user by selecting personalized portions of the media content and tailoring the selected personalized portions of the media content into a program guide for viewing on the display as user's personalized visual presentation;
constructing different personalized visual presentations of correspondingly selected personalized portions of the media content, respectively for the plurality of users accessing the processing system at the single location; and
responding to a unique authentication information from an accessing user to display a corresponding personalized visual presentation to the accessing user of the plurality of users that constructed the personalized visual presentations.

18. The method of claim 17, when constructing the different personalized visual presentations, also providing for broadcast channels to be included for selection in the personalized visual presentations.

19. The method of claim 17, wherein when constructing the different personalized visual presentations, also providing for third party content to be included for selection in the personalized visual presentations.

20. The method of claim 17, wherein the unique authentication information is a password entered by the accessing user in order to bring up the accessing user's personalized visual presentation on the display.
